(19) United States
(12) Patent Application Publication
(10) Pub. No.: US 2009/0106996 A1
(43) Pub. Date: Apr. 30, 2009

(54) Measuring Canister Valve Alignment

(75) Inventor: Ian Fletcher, Loughborough (GB)

Correspondence Address: FISH & RICHARDSON P.C., P.O BOX 1022, MINNEAPOLIS, MN, 55440-1022, US

(73) Assignee: ASTRAZENECA AB

(21) Appl. No.: 12/258,003

(22) Filed: Oct. 24, 2008

Related U.S. Application Data
(60) Provisional application No. 60/982,757, filed on Oct. 26, 2007.

(51) Int. Cl. G01D 21/00

(52) U.S. Cl. 33/645

(57) ABSTRACT

In one implementation, an inhaler valve alignment measurement device includes an extended pointer arranged in alignment with a first canister member, e.g. a valve stem or a valve base, and an extended reference member arranged in alignment with a second canister member, e.g. a valve base or a canister wall. The extended reference member includes a visual alignment indicator indicative of the relative alignment of the extended pointer and the extended reference member at a predetermined distance from the canister members.

This application claims the benefit of the filing date of U.S. Provisional Application No. 60/982,757, which was filed on Oct. 26, 2007. The contents of U.S. Application No. 60/982,757 are incorporated by reference in their entirety as part of this application.

### TECHNICAL FIELD

The invention relates to measuring valve alignment of an inhaler, including, for example, a pressurized metered dose inhaler (hereinafter referred to as a “pMDI”), and devices that perform such measurement.

### BACKGROUND

pMDIs are well known in the art of inhalation devices. It is therefore not necessary to describe the construction and operation of a pMDI other than in bare essentials.

A pMDI comprises a canister unit and a housing. The housing is generally tubular and formed of a plastic material, for instance by molding. The canister unit comprises a canister having one open end, typically made from a metal such as aluminum. The open end of the canister is sealingly capped by a metering valve assembly. The valve assembly includes a hollow dispensing member, usually in the form of a valve stem, which projects from the open end of the canister. Actuation of the metering valve assembly results in a metered dose of the aerosol formulation being dispensed from the canister through the valve stem.

In use, the sealed canister contains a pressurized medicinal aerosol formulation. The formulation comprises the medicament and a fluid propellant, and optionally one or more excipients and/or adjuvants. The medicament is typically in solution or suspension in the formulation.

The housing comprises an internal passageway having an open end. A nozzle block, is arranged to receive the valve stem from the canister unit, and to direct the dispensed metered dose to a mouth piece (or nasal piece). In use, a patient in need of a metered dose of the medicinal aerosol formulation concurrently inhales on the mouthpiece and actuates the canister unit. The inspiratory airflow produced by the patient entrains the metered dose of the medicinal aerosol formulation into the patient's respiratory tract.

U.S. Pat. No. 6,415,526 disclose an apparatus for measuring the alignment of a valve sealed onto a canister comprises hollow lower and upper sections, a mounting platform, and a transducer. The upper and lower interior regions cooperatively define an inner chamber in which the mounting platform is disposed. The transducer is mounted to the upper section and includes a probe extending through the upper section and into the inner chamber. The apparatus is adapted for relative rotational movement between the mounting platform and the upper section. The transducer is responsive to linear translation of the probe and displays a human-readable indication of the alignment of a valve sealed in a canister as the probe moves around the circumference of the top surface of the valve.

### SUMMARY

In one implementation, an inhaler valve alignment measurement device includes an extended pointer arranged in alignment with a first canister member, e.g. a valve stem or a valve base, and an extended reference member arranged in alignment with a second canister member, e.g. a valve base or a canister wall. The extended reference member includes a visual alignment indicator indicative of the relative alignment of the extended pointer and the extended reference member at a predetermined distance from the canister members.

Some implementations may align the first canister member with the valve stem and the second canister member with the valve base. Some implementations may align the first canister member with the valve base,and the second canister member with the canister wall.

In some implementations, the extended pointer and the extended reference member extend in alignment with the longitudinal direction of the canister. In some implementations, the the extended pointer and the extended reference member extend transverse to the longitudinal direction of the canister.

Additionally, in some implementations the extended reference member is a substantially tube shaped sleeve having a canister end arranged to be fitted on the second canister member and an indicator end. Further, the extended reference member is arranged to surround the alignment pointer.

In some implementations, the visual alignment indicator includes one or more concentric circles centered about the point of alignment. Further, some implementations also include a second extended reference member arranged in alignment with the second canister member. The second extended reference member includes a second visual alignment indicator indicative of the relative alignment of the first and second extended reference members.

Further, some implementations include an image registration unit arranged to register a view of the visual alignment indicator, and an image processing system arranged to extract alignment data from the registered view.

Another aspect includes a method for detecting valve misalignment of a pressurized metered dose inhaler canister including aligning an extended pointer with a first canister member, aligning an extended reference member with a second canister member, and registering the relative alignment of the extended reference member and the extended pointer. The extended reference member including a visual alignment indicator indicating the relative alignment of the extended pointer and the extended reference member at a predetermined distance from the canister members so that the valve misalignment is detected based on the registered relative alignment. In some implementations, registering the relative alignment of the extended pointer and the extended reference member includes, for example registering a degree of misalignment and/or registering a direction of misalignment.

In some implementations, the method also includes aligning a second extended reference member with the second canister member. The second extended reference member includes a second visual alignment indicator indicating a relative alignment of the first and second extended reference members. The method also includes registering the relative alignment of the first and second extended reference members, so that the valve misalignment is also detected based on the relative alignment of the first and second extended reference members.

In some implementations, registering the relative alignment of the extended pointer and the extended reference member includes, for example registering a degree of misalignment and/or registering a direction of misalignment.

In another aspect, a method for detecting valve misalignment of a pressurized metered dose inhaler canister includes aligning an extended pointer with a first canister member, aligning a first extended reference member with a second canister member, aligning a second extended reference member with the second canister member, and registering the relative alignment of the extended pointer and the first extended reference member and the relative alignment of the first and second extended reference members. The first extended reference member includes a first visual alignment indicator indicating a relative alignment of the extended pointer and the first extended reference member at a predetermined distance from the canister members. The second extended reference member includes a second visual alignment indicator indicating a relative alignment of the first and second extended reference members. The valve misalignment is detected based on the registered relative alignment of the extended pointer and the first and second extended reference members.

In some implementations, registering the relative alignment of the extended pointer and the first extended reference member and the relative alignment of the first and second extended reference members includes, for example registering a degree of misalignment and/or registering a direction of misalignment.

The device described herein is very simple yet reliable in its design, and may be configured with few moving parts and for efficient manufacturing and assembly. Use of the device as described herein may result in a measurement providing a direct and intuitive reading of the degree of misalignment and the direction thereof.

The details of one or more examples of the invention are set forth in the accompanying drawings and the description below. Other features, objects, and advantages of the invention will be apparent from the description and drawings, and from the claims.

### BRIEF DESCRIPTION OF DRAWINGS

FIG. 1 schematically shows a sectional view of an inhaler can for containing a pharmaceutical substance in a pressurized propellant to be included in an inhalation device.

FIGS. 2a-2d schematically show a first example of a device for measuring valve alignment.

FIGS. 3a-3d schematically show another example of a device for measuring valve alignment.

FIGS. 4a and 4b schematically show another example of a device for measuring valve alignment.

FIG. 5 schematically shows still another example of a device for measuring valve alignment.

FIGS. 6a and 6b schematically show another example of a device for measuring valve alignment.

FIGS. 7a and 7b schematically show another example of a device for measuring valve alignment.

FIGS. 8a and 8b schematically show another example of a device for measuring valve alignment.

Like reference symbols in the various drawings indicate like elements.

### DETAILED DESCRIPTION

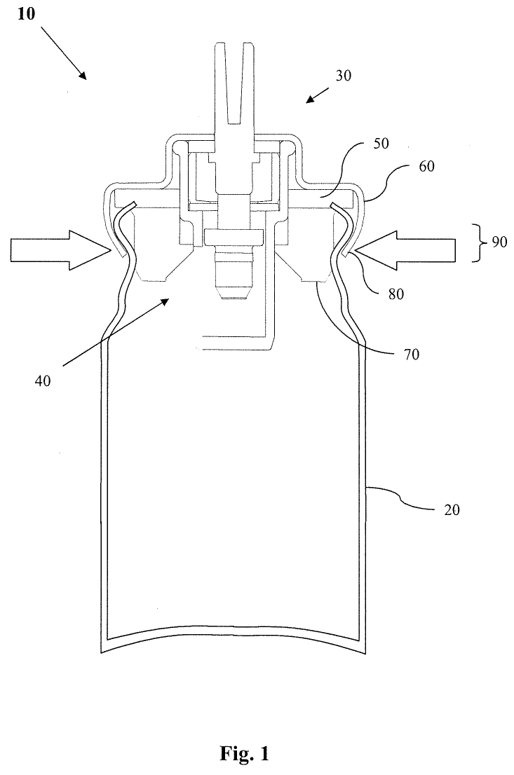

FIG. 1 shows a sectional view of one example of an inhaler container 10 (canister). The inhaler canister 10 is comprised of a can 20 and a valve assembly 30. Due to the high pressure of the propellant, the valve assembly must be firmly attached to the can 20. The valve assembly is basically comprised of a valve mechanism 40, a gasket 50, a ferrule 60, and a support ring 70. As can be seen in FIG. 1 the valve assembly 30 is attached to the can 20 by a crimp 80, i.e. the lower section 90 of the ferrule 60 is crimped in a crimping apparatus so that it closely clasps the upper section of the can 20. Further, the inhaler can 10 is sealed as the upper edge of the can 20 is pressed against the gasket 50 by the crimp 80.

This design gives a reliable and safe container that is simple to produce. However during production, resulting valve alignment must be carefully controlled, because the quality of the crimping process by which the valve cap is sealed onto the canister is of utmost criticality. Even a slight defect in the resulting crimp might constitute an improperly sealed valve cap. That is, because of the significant pressure differential between the interior of the canister and the ambient air, the slightest leak will render the canister commercially valueless. By the time the defective canister has been distributed to the patient, most or all of the propellant will have escaped the confines of the canister. As a result, the pressure differential has been eliminated and the canister rendered inoperative.

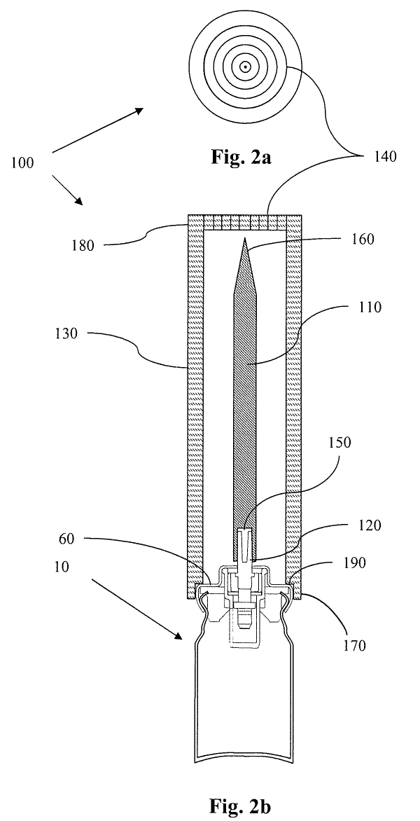

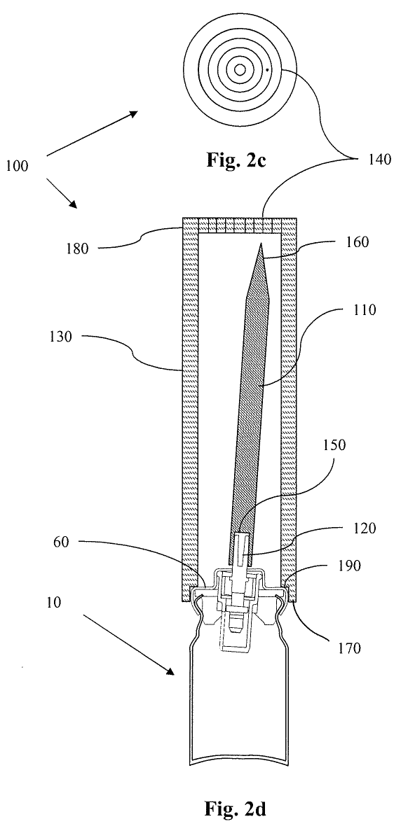

FIG. 2b schematically shows a first example of a device 100 for measuring valve alignment of a pressurized metered dose inhaler canister 10 in a cross sectional view, and FIG. 2a in a top view. The device 100 for measuring valve alignment comprises an extended pointer in the form of an elongated pointer 110 arranged in alignment with a first canister member, here a valve stem 120, and an extended reference member 130 arranged in alignment with a second canister member, here the ferrule 60. The reference member 130 is provided with visual alignment indicator means 140 indicative of the relative alignment of the elongated pointer 110 and the reference member 130 at a distance from the canister members 120, 60.

In some examples, the elongated pointer 110 is formed as a pointed rod of circular cross section. The pointer 110 is provided with suitable means for fitting it to the first canister member in an aligned relationship. In FIG. 2b the means for attaching the pointer 110 to the valve stem 120 is an aligned recess 150 that fits snuggly on the valve stem 120. The pointer 110 can be made of any suitable rigid material, and is provided with a tip 160 at the upper distal end.

In some examples, the reference member 130 is a generally tube shaped sleeve with a canister end 170 arranged to be fitted on the second canister member and an indicator end 180. The reference member 130 can be arranged to surround the alignment pointer 110 along their extension. The reference member 130 is provided with suitable means for fitting it on the second canister member in an aligned relationship. In FIG. 2b the means for fitting the reference member 130 on the ferrule 60 is comprised of a collar 190 that fits on the ferrule 60 so that the reference member 130 is aligned with the ferrule. In some examples, the visual alignment indicator means 140 is comprised of one or more concentric circles centered about the point of alignment. The circles may be printed on a transparent top surface of the reference member 130, whereby the tip of the pointer 110 is visible there through, and hence the relative alignment of the first and second canister members is directly readable as the offset of the tip of the pointer 110 from the point of alignment.

FIG. 2a schematically shows a top view of the device 100 for measuring valve alignment and hence the visual alignment indicator means 140, in perfect alignment. FIGS. 2c and 2d correspond to FIGS. 2a and 2b, respectively, but show the valve assembly misaligned. From FIG. 2d it can be seen that the elongated pointer 10 enhances the possibility to detect and register the degree of misalignment. FIG. 2c shows the corresponding read out of the visual alignment indicator means 140. As can be seen, any misalignment is very easy to detect, at the same time as the direction of the misalignment is clearly displayed.

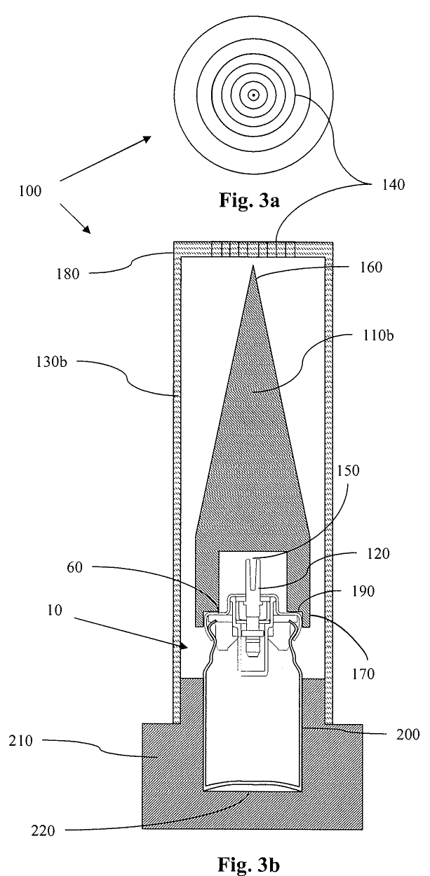

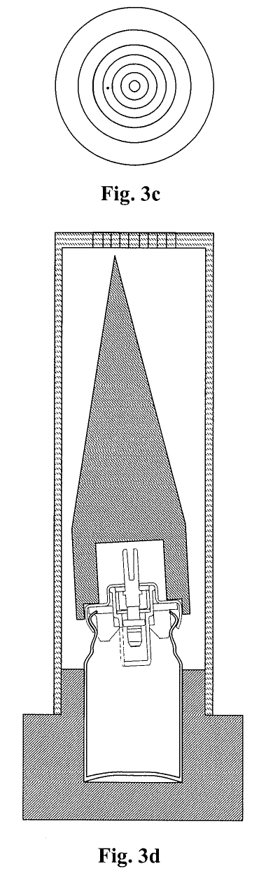

FIGS. 3a to 3d schematically show corresponding views of a second example of a device 100 for measuring valve alignment of a pressurized metered dose inhaler canister 10 wherein the first canister member is the ferrule 60 and the second canister member is the canister wall 200. In this example, an elongated pointer 110b is fitted on the ferrule 60 like the reference member 130 of the example of FIGS. 2a to 2d, but is formed with a pointer end 160. In the disclosed example, a reference member 130b is arranged in alignment with the canister 10 by means of a reference base 210 comprising a canister recess 220. In the disclosed example, the reference member 130b is a generally tube shaped sleeve with a canister end 170 arranged to be fitted on the second canister member and an indicator end 180 and the reference member 130b is arranged to surround the alignment pointer 110 along their extension. Like above, FIGS. 3c and 3d correspond to FIGS. 2a and 2b, respectively, but wherein the valve assembly is misaligned.

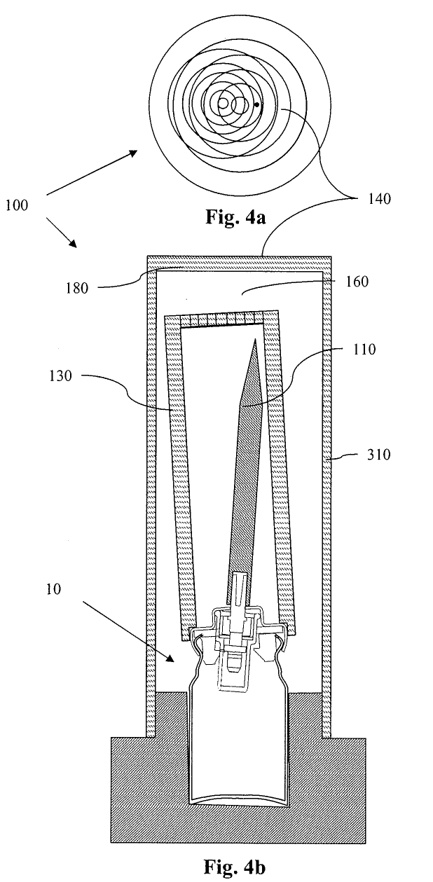

FIGS. 4a and 4b schematically show corresponding views of a third example of a device 100 for measuring valve alignment of a pressurized metered dose inhaler canister 10. This example combines features of the example of FIGS. 2a to 2d with a second elongated reference member 310 arranged in alignment with the canister wall, as discussed with respect to FIGS. 3a to 3d. The second reference member 310 is provided with a second visual alignment indicator means indicative of the relative alignment of the first and second reference members. FIGS. 3a and 3b schematically show one example wherein the valve assembly is misaligned both with respect to the valve stem 120 and the ferrule 60. From FIG. 4b it can be seen that the elongated pointer 110 together with the elongated first reference member 130 makes it possible to simultaneously detect and register the degree of misalignment both for the valve stem 120 and the ferrule 60. FIG. 4a shows the corresponding read out of the visual alignment indicator means 140. As can be seen, any misalignment is possible to detect, at the same time as the direction of the misalignment is clearly displayed. In order to facilitate the read out of the individual misalignment of the valve stem 120 and the ferrule 60, respectively, the visual alignment indicator means 140 of the two reference members 130 and 310 can be printed in different colors.

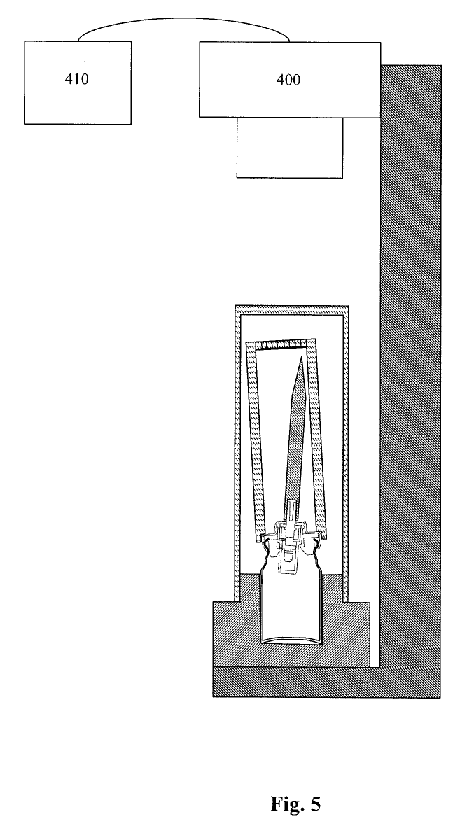

In the example shown in FIG. 5, the device 300 for measuring valve alignment of a pressurized metered dose inhaler canister 10 includes an image registration unit 400 arranged to register the view of the alignment indicator means 140, and an image processing system 410 arranged to extract alignment data from the registered view according to FIG. 4c. As in the above examples, the alignment data provided with the automatic process according to this example, will contain both the degree and direction of misalignment. The alignment data can then be used to evaluate whether the canister 10 can be used or if it should be discarded.

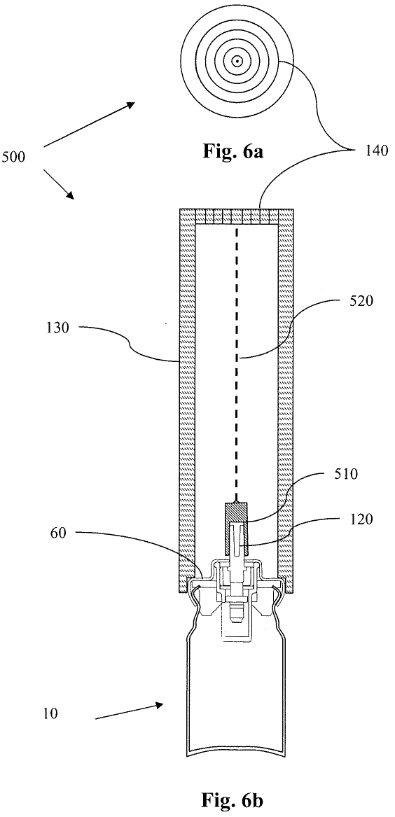

FIGS. 6a and 6b show an example of a device 500 for measuring valve alignment similar to the example of FIGS. 2a to 2d, but in which the elongated pointer 110 is replaced by a light pointer 510 that emits an aligned narrow ray of light 520 that is visually detectable in relation to the visual alignment means 140. The light pointer 500 may be a laser pointer or any other light pointer capable of producing a narrow ray of light at the visual alignment means 140.

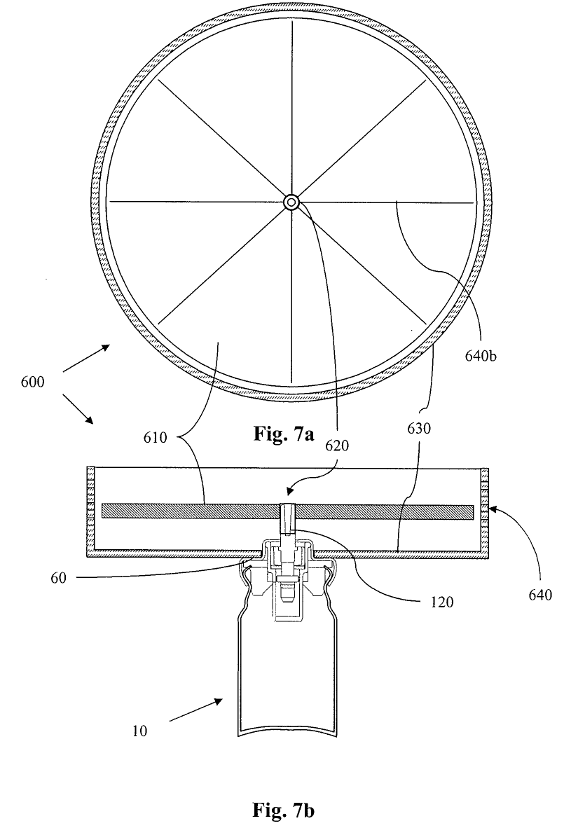

FIGS. 7a and 7b schematically show views corresponding to FIGS. 2a and 2b of a another example of a device 600 for measuring valve alignment of a pressurized metered dose inhaler canister 10, in which the extended pointer 610 extends transverse to the longitudinal direction of the canister 10. According to this example, the extended pointer 610 is disc shaped with a valve stem receiving hole or recess 620 arranged so that the disc is in transverse alignment with the valve stem 120. An extended reference member 630 is fitted on and in alignment with the ferrule 60. The reference member 630 is provided with visual alignment indicator means 640 indicative of the relative alignment of the extended pointer 610 and the reference member 630 at a distance from the canister members 120, 60. In the disclosed example, the reference member 630 comprises a wide cylindrical section that surrounds the disc shaped pointer 610, and the alignment indicator means 640 is provided on the cylindrical section. In order to indicate the direction of a misalignment direction indicator means 640b are provided on the disc shaped pointer 610.

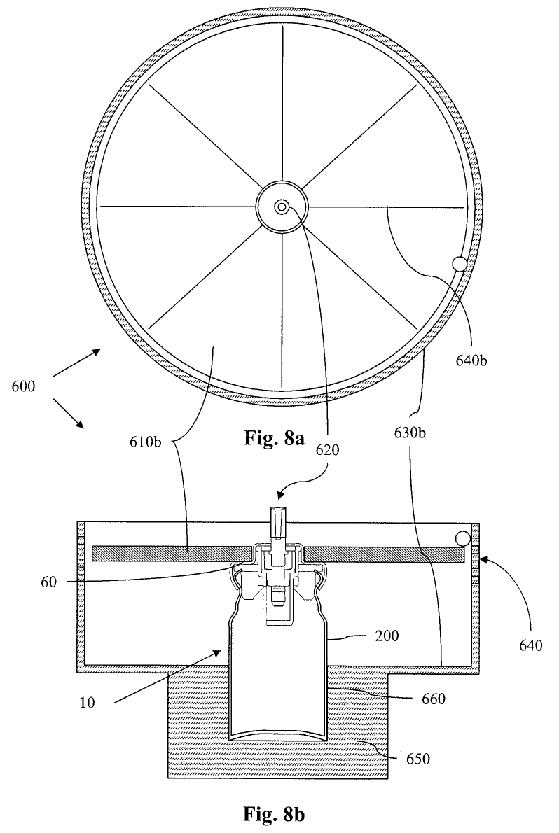

FIGS. 8a and 8b schematically show corresponding views of an example similar to that of FIGS. 7a and 7b, in which the first canister member is the ferrule 60 and the second canister member is the canister wall 200. In this example, an extended disc shaped pointer 610b is fitted on the ferrule 60 like the reference member 630 of the example of FIGS. 7a and 7b. In the disclosed example, an extended reference member 630b is arranged in alignment with the canister 10 by means of a reference base 650 comprising a canister recess 660. In the disclosed example, the reference member 630b comprises a wide cylindrical section that surrounds the disc shaped pointer 610b, and the alignment indicator means 640 is provided on the cylindrical section. Provided that the reference base 650 is arranged in level, a ball 670 placed on the disc shaped pointer 610b may be used to find the direction of any misalignment in a fast and intuitive way, after which the degree of misalignment is read from the alignment indicator means 640.

In alternative examples, the extended pointer and the reference member may extend in other directions than the ones specifically disclosed, and the pointer and reference member may be formed in many ways other than the disclosed examples.

A number of examples of the invention have been described. Nevertheless, it will be understood that various modifications may be made without departing from the spirit and scope of the invention. Accordingly, other examples are within the scope of the following claims.

What is claimed is:

1. An inhaler valve alignment measurement device comprising
an extended pointer arranged in alignment with a first canister member, and
an extended reference member arranged in alignment with a second canister member,
wherein the extended reference member comprises a visual alignment indicator indicative of relative alignment of the extended pointer and the extended reference member at a predetermined distance from the canister members.

2. The device of claim 1 wherein the first canister member is a valve stem and the second canister member is a valve base.

3. The device of claim 1 wherein the first canister member is a valve base and the second canister member is a canister wall.

4. The device of claim 1 wherein the extended pointer and the extended reference member extend in alignment with the longitudinal direction of the canister.

5. The device of claim 1 wherein the extended pointer and the extended reference member extend transverse to the longitudinal direction of the canister.

6. The device of claim 1 wherein the extended reference member is a substantially tube shaped sleeve having a canister end arranged to be fitted on the second canister member and an indicator end, and wherein the extended reference member is arranged to surround the alignment pointer.

7. The device of claim 1 wherein the visual alignment indicator comprises one or more concentric circles centered about the point of alignment.

8. The device of claim 1 comprising a second extended reference member arranged in alignment with the second canister member, wherein the second extended reference member comprises a second visual alignment indicator indicative of the relative alignment of the first and second extended reference members.

9. The device of claim 1 further comprising an image registration unit arranged to register a view of the visual alignment indicator, and an image processing system arranged to extract alignment data from the registered view.

10. A method for detecting valve misalignment of a pressurized metered dose inhaler canister, the method comprising:
aligning an extended pointer with a first canister member;
aligning an extended reference member with a second canister member, the extended reference member comprising a visual alignment indicator indicating a relative alignment of the extended pointer and the extended reference member at a predetermined distance from the canister members; and
registering the relative alignment of the extended pointer and the extended reference member, wherein valve misalignment is detected based on the registered relative alignment of the extended pointer and the extended reference member.

11. The method of claim 10 wherein registering the relative alignment of the extended pointer and the extended reference member comprises registering a degree of misalignment.

12. The method of claim 10 wherein registering the relative alignment of the extended pointer and the extended reference member comprises registering a direction of misalignment.

13. The method of claim 10 wherein the extended reference member is a first extended reference member and the visual alignment indicator is a first visual alignment indicator, the method further comprising
aligning a second extended reference member with the second canister member, the second extended reference member comprising a second visual alignment indicator indicating a relative alignment of the first and second extended reference members; and
registering the relative alignment of the first and second extended reference members, wherein the valve misalignment is also detected based on the relative alignment of the first and second extended reference members.

14. The method of claim 13 wherein registering the relative alignment of the extended pointer and the extended reference member comprises registering a degree of misalignment.

15. The method of claim 13 wherein registering the relative alignment of the extended pointer and the extended reference member further comprises registering a direction of misalignment.

16. The method of claim 13 wherein registering the relative alignment of the first and second extended reference members comprises registering a degree of misalignment.

17. The method of claim 13 wherein registering the relative alignment of the first and second extended reference members comprises registering a direction of misalignment.

18. A method for detecting valve misalignment of a pressurized metered dose inhaler canister, the method comprising:
aligning an extended pointer with a first canister member;
aligning a first extended reference member with a second canister member, the first extended reference member comprising a first visual alignment indicator indicating a relative alignment of the extended pointer and the first extended reference member at a predetermined distance from the canister members;
aligning a second extended reference member with the second canister member, the second extended reference member comprising a second visual alignment indicator indicating a relative alignment of the first and second extended reference members; and
registering the relative alignment of the extended pointer and the first extended reference member and the relative alignment of the first and second extended reference members, wherein valve misalignment is detected based on the registered relative alignment of the extended pointer and the first extended member and the relative alignment of the first and second extended reference members.

19. The method of claim 18 wherein registering the relative alignment of the extended pointer and the first extended reference member and the relative alignment of the first and second extended reference members comprises registering a degree of misalignment.

20. The method of claim 19 wherein registering the relative alignment of the extended pointer and the first extended reference member and the relative alignment of the first and second extended reference members further comprises registering a direction of misalignment.
